(19) United States
(12) Patent Application Publication
(10) Pub. No.: US 2017/0290058 A1
(43) Pub. Date: Oct. 5, 2017

(54) SYSTEMS AND METHODS FOR AVOIDING HIDDEN NODE COLLISIONS

(71) Applicants: Sarabjot Singh, Santa Clara, CA (US); Ping Wang, Santa Clara, CA (US); Shu-Ping Yeh, New Taipei City (TW); Feng Xue, Redwood City, CA (US); Yang-Seok Choi, Portland, OR (US)

(72) Inventors: Sarabjot Singh, Santa Clara, CA (US); Ping Wang, Santa Clara, CA (US); Shu-Ping Yeh, New Taipei City (TW); Feng Xue, Redwood City, CA (US); Yang-Seok Choi, Portland, OR (US)

(21) Appl. No.: 15/088,718

(22) Filed: Apr. 1, 2016

(51) Int. Cl. H04W 74/08

(52) U.S. Cl. CPC H04W 74/0816

(57) ABSTRACT

Disclosed herein are systems and methods that are directed to alleviating the hidden node problem occurring in wireless systems by using the simultaneous transmission and reception (STR) capability without increasing the medium access layer (MAC) overhead. Accordingly, a receiving device receiving a data packet from a transmitting device can simultaneously transmit a data packet, called a STR Clear to Send (CTS). This STR-CTS can create a guard zone around the receiving device to avoid collisions from unwanted transmissions from secondary devices, e.g., neighboring STAs and/or APs. In various embodiments, the STR-CTS packet transmitted by the receiving device can be decodable by legacy devices, e.g. legacy STAs and APs, as well as next generation devices, for example, those employing unlicensed technologies such as LAA.

### TECHNICAL FIELD

This disclosure generally relates to systems and methods for wireless communications and, more particularly, systems and methods to avoid hidden node collisions.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation.

Conventional systems and methods for access to unlicensed bands are generally preceded by contention-based protocols (CBP), communications protocols that allow many users to use the same radio channel without pre-coordination. The “listen before talk” (LBT) operating procedure in IEEE 802.11 and/or “clear channel assessment” (CCA) protocols (defined in the IEEE 802.11-2007 standards) are two examples of such CBPs through which a transmitting device can determine the presence of ongoing transmissions in the same channel.

With these and similar methods, an access point (AP) and/or station (STA) can sense the channel prior to transmitting buffered data. The AP and/or STA may then determine to transmit data if the channel is idle, for example, the detected energy on the channel is below a pre-determined threshold. Some wireless standards (e.g., the IEEE 802.11 standard) specify a threshold associated with CCA and/or LBT. For example, the signal detect threshold can be approximately −82 dBm, and the energy threshold can be approximately −62 dBm for 20 MHz orthogonal frequency-division multiplexing (OFDM) transmission. This can create a radio frequency (RF)-energy based guard zone around each transmitting device that can preclude other transmitting devices in this guard zone from reusing the medium.

However, in dense deployment situations, these protocols can lead to a hidden node problem. The hidden node problem can refer to a situation where a given STA is visible to a transmitting device, but not from other STAs communicating with that transmitting device, potentially causing collisions and/or interference at a receiving device. One way to address this problem is the use of Request to Send/Clear to Send (RTS/CTS) message exchange (as defined, for example, in IEEE 802.11). The RTS/CTS message exchange can enable the creation of a guard zone around transmitting and receiving devices. Such guard zones can represent areas where any STA within a pre-determined distance from a receiving device is not allowed to transmit data. However, this additional RTS/CTS message exchange can increase the overhead and reduce the efficiency of the medium access layer (MAC).

### BRIEF DESCRIPTION OF THE DRAWINGS

FIG. 1 shows an example network environment, in accordance with embodiments of the systems and methods disclosed herein.

FIG. 2 shows a diagram of example data exchanges, in accordance with embodiments of the systems and methods disclosed herein.

FIG. 3 shows a diagram illustrating an example data frame, in accordance with embodiments of the systems and methods disclosed herein.

FIG. 4 shows a diagram illustrating the communication among different transmitting devices and receiving devices in an example wireless network environment, in accordance with embodiments of the disclosure.

FIG. 5 shows a flowchart of the operation of an example transmitting device, in accordance with embodiments of the systems and methods disclosed herein.

FIG. 6 shows a flowchart of the operation of an example receiving device, in accordance with embodiments of the systems and methods disclosed herein.

FIG. 7 shows a flowchart of the operation of an example secondary transmitting device, in accordance with embodiments of the systems and methods disclosed herein.

FIG. 8 illustrates a functional diagram of an example communication station that may be suitable for use as a user device, in accordance with one or more example embodiments of the disclosure.

FIG. 9 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for providing signaling information to Wi-Fi devices in various Wi-Fi networks, including, but not limited to, IEEE 802.11ax (referred to as HE or HEW). In other respects, example embodiments described herein provide certain systems, methods, and devices for wireless communication, and in particular, to IEEE 802.11 standard and 3rd Generation Partnership Project (3GPP) standards pertaining to licensed-assisted access (LAA) and also, to Long-Term Evolution (LTE) in unlicensed spectrum.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

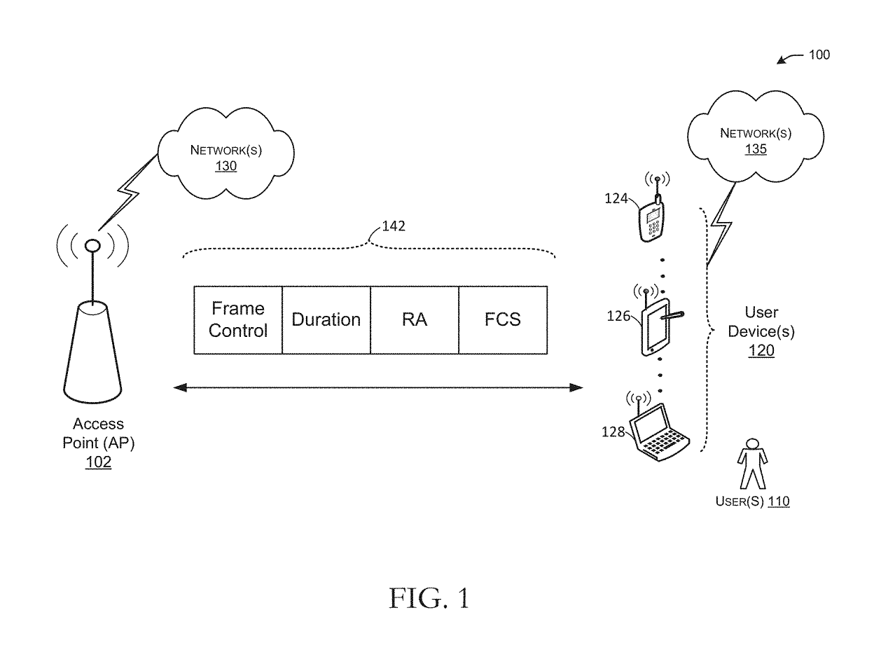

Disclosed herein are systems and methods that are directed to alleviating the hidden node problem occurring, for example, in wireless local area network (WLAN), LTE LAA, and LTE in unlicensed spectrum systems using a simultaneous transmission and reception (STR) mechanism without increasing the medium access layer (MAC) overhead. Accordingly, a receiving device (e.g., an STA and/or an AP, 124, 126, and 128 as shown in FIG. 1) receiving a data packet from a transmitting device (e.g., an STA and/or an AP 102 as shown in FIG. 1) can simultaneously transmit a data packet, called herein a STR Clear to Send (STR-CTS) packet 142. This STR-CTS may lead to the creation of a RF energy-based guard zone around the receiving device to avoid collisions from unwanted transmissions from secondary devices, e.g., neighboring STAs and/or APs. In various embodiments, the STR-CTS packet transmitted by the receiving device can be decodable by legacy devices, e.g. legacy STAs and APs, as well as next generation devices, for example, those employing unlicensed technologies such as LAA. For instance, the STR-CTS packet can be short and highly coded like traditional CTS messages, to allow for decodability by such legacy devices in addition to being decodable by LAA-enabled devices.

Previous approaches have involved transmitting devices and receiving devices employing dummy packets for the entire duration of data exchange to avoid collisions. However, such approaches may require a specification change for WLAN; moreover, data sent by LAA transmitting devices may not be decodable by WLAN receiving devices. The systems and methods disclosed herein can have several advantages over these and other conventional approaches. An example advantage of the systems and methods disclosed herein is that the hidden node problem can be avoided and the number of collisions can be decreased without increasing the MAC overhead. Another example advantage is that legacy APs and STAs as well as newer LAA enabled APs and STAs can decode the STR-CTS packets. Consequently, they can defer data transmission, leading to reduced collisions in the network.

Disclosed herein are systems and methods directed to using STR at the receiving device to transmit a STR-CTS packet while receiving a transmission in order to prevent collision caused by the transmission of hidden nodes.

FIG. 1 is a network diagram illustrating an example network environment, according to some example embodiments of the present disclosure. Wireless network 100 may include one or more devices 120 and one or more access point(s) (AP) 102, which may communicate in accordance with IEEE 802.11 communication standards, including IEEE 802.11ax. The device(s) 120 may be mobile devices that are non-stationary and do not have fixed locations.

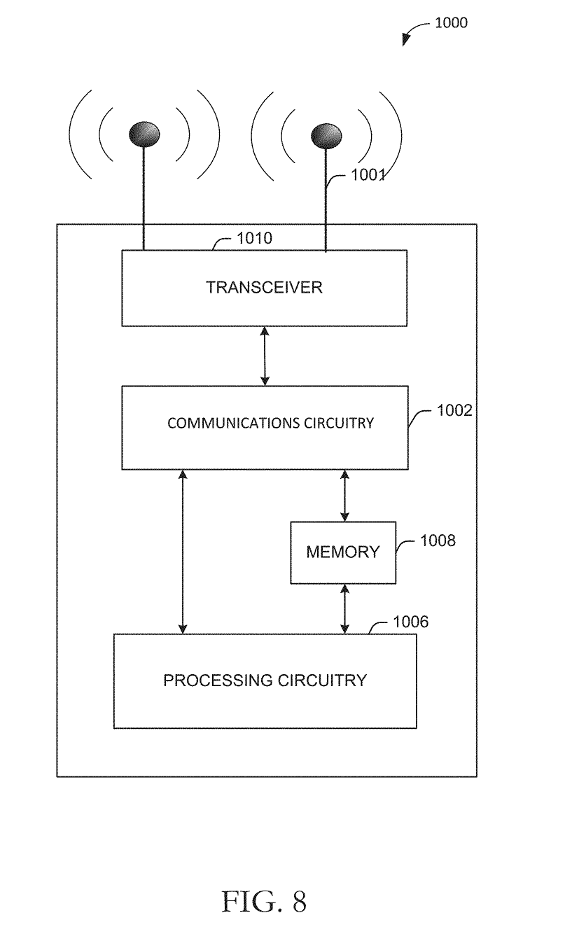

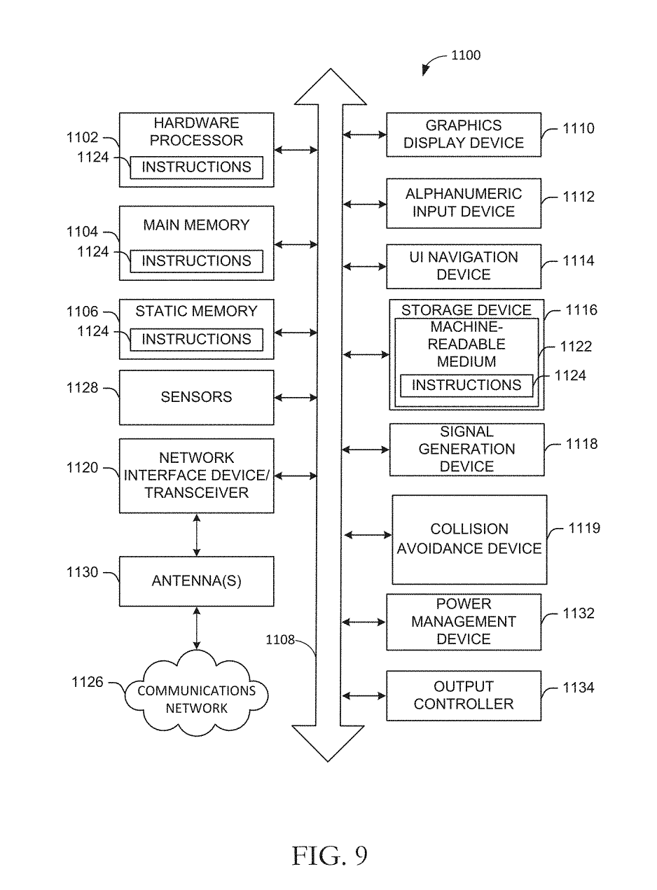

The user device(s) 120 (e.g., user devices 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth. In some embodiments, the user devices 120 and AP 102 may include one or more computer systems similar to that of the functional diagram of FIG. 8 and/or the example machine/system of FIG. 9, to be discussed further.

Returning to FIG. 1, any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 102) establishes communication with one or more user devices 120 (e.g., user devices 124, 126, and/or 128), the AP may communicate in the downlink direction by sending data frames (e.g., data frames 142). The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and user devices).

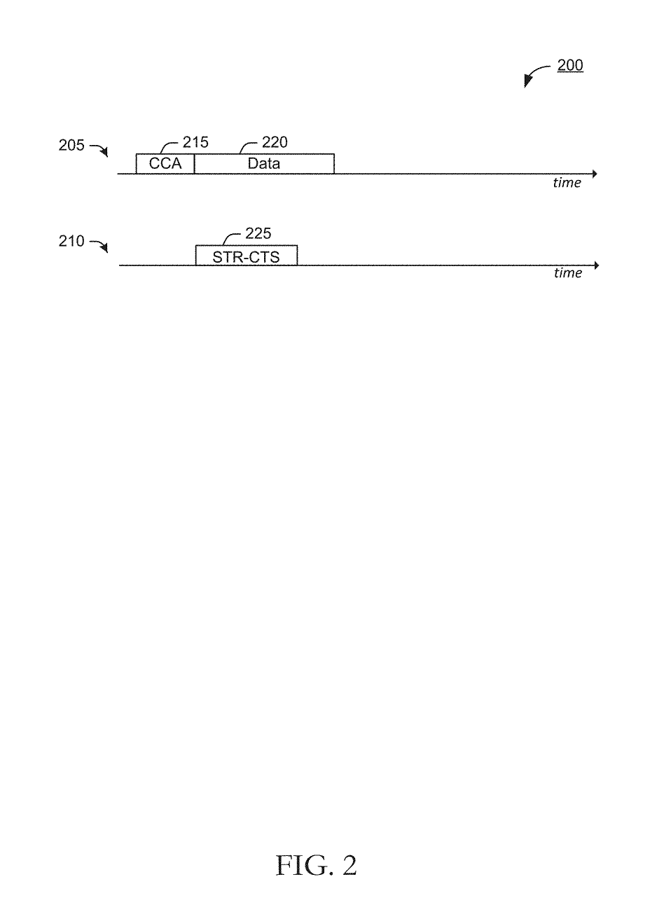

FIG. 2 shows a diagram illustrating an aspect of the disclosure. As shown in FIG. 2, a transmitting device 205 (e.g., the AP 102 of FIG. 1) and a receiving device 210 (e.g., user device 120 of FIG. 1) engage in data exchange. The transmitting device 205 can first perform a contention-based protocol (CBP) such as a “listen before talk” (LBT) or a “clear channel assessment” (CCA) 215. The transmitting device 205 can then begin data transmission 220 to the receiving device 210. Upon reception of the data from the transmitting device 210, an STR-CTS packet 225 can be transmitted by the receiving device 210 to the transmitting device 205 and neighboring STAs and/or APs (not shown). In some embodiments, the receiving device 210 can transmit the STR-CTS 225 after it decodes the data header of the received data packet 220 and verifies that the data is addressed to it. As a result of the transmission of STR-CTS 225 by the receiving device 210, nearby STAs and/or receiving devices (not shown) which would otherwise be hidden can detect the ongoing transmission and defer their own transmission. This can result in lowering the number of collisions in the network without increasing MAC overhead. In some embodiments, the STR-CTS can be generated with the lowest modulation and coding scheme (MCS) to enable the largest decoding range. In another embodiment, the receiving device may transmit a plurality of STR-CTSs, for example, over pre-determined time-duration to enable a continuous guard zone.

In one embodiment, if the transmitting device has full-duplex (FD) capability, the receiving device can be made aware of the transmitting device's FD capability during an Initial Association Process (TAP) between the receiving device and transmitting device, and vice versa. This can allow the STR-CTS to also serve as an immediate CTS message to enable early congestion detection. In such situations, the transmitting device can expect an immediate STR-CTS transmission from destination node with FD capability. The transmitting device can terminate transmission earlier if no STR-CTS is detected within pre-determined time window. In some embodiments, if the receiving device has uplink data of its own, it can be sent in conjunction with the STR-CTS packet to use the available wireless resources more efficiently. In various embodiments, STR and FD can be used interchangeably in the disclosure.

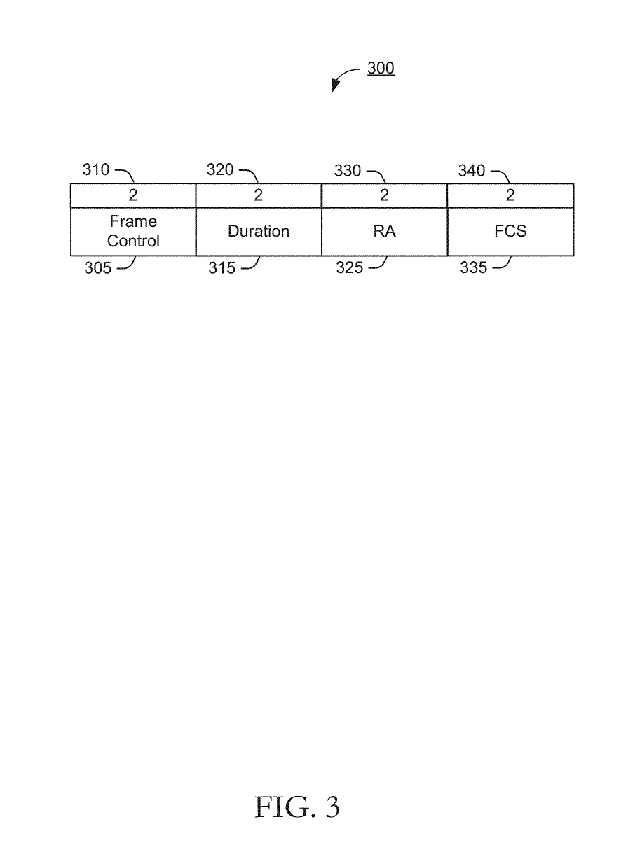

FIG. 3 shows an example packet structure 300 for the STR-CTS packet. The various fields shown in FIG. 3 can be specified as follows. The Frame control field 305 can provide specifying the form and function of the frame, and can be, for example, 2 bytes, 310. The duration field 315 can indicate the duration of the data Transmit Opportunity (TXOP), and can be, for example, 2 bytes, 320. The RA field 325 can indicate the address of the transmitting device, and can be, for example, 6 bytes. In various embodiments, there can be several RA fields (not shown), where each RA field indicates the address of transmitting devices in the neighborhood of a give receiving device. The frame check sequence (FCS) field 335 can provide an extra error-detecting code added to the frame for error checking, and can be, for example, 4 bytes, 340. In some embodiments the data frame structure may be similar to that of CTS/ACK in IEEE 802.11. This can allow it to be decodable by legacy WLAN STAs as well non-legacy STAs.

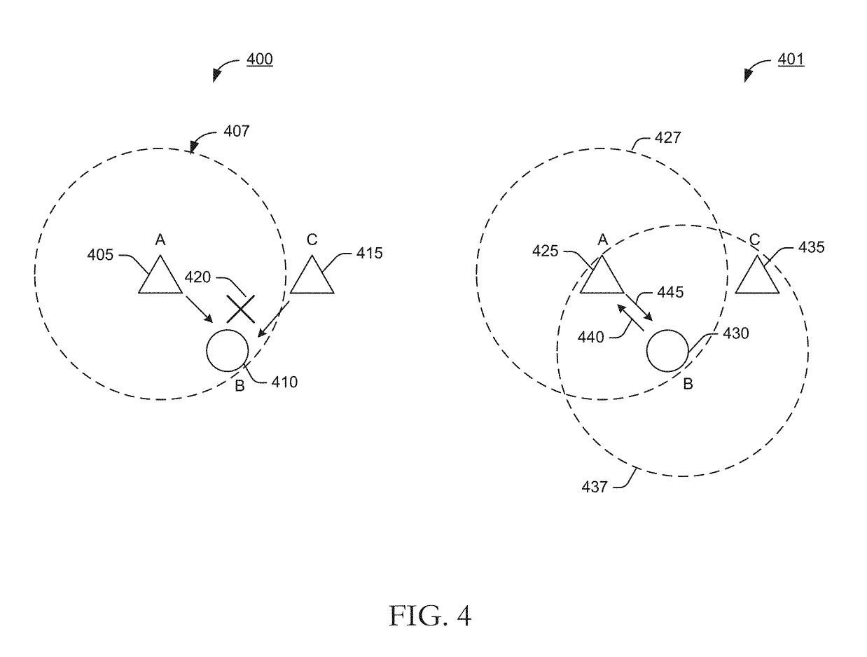

FIG. 4 shows a diagram of a communication among different transmitting devices and receiving devices in an example wireless network environment in accordance with the disclosure. FIG. 4 illustrates a guard zone 407 created by a transmitting device 405 engaged in data exchange as compared with a guard zone 437 created by a receiving device 430 transmitting STR-CTSs in addition to the guard zone 427 created by the transmitting device 425.

In 400, transmitting device A 405 initiates transmission towards receiving device B 410. A secondary device C 415 cannot detect the data exchange between transmitting device A and receiving device B because it lies outside the radius of the guard zone 407 of transmitting device A 405. As a result, transmitting device C 415 may also transmit data (either directly to receiving device B 410 as shown, or to another device (not shown) in the direction of device B 410, for example with an omnidirectional transmission). This can result in a collision 420 at the receiving device B 416.

Alternatively, in 401, receiving device B 430 can transmit a STR-CTS 440 as soon as transmitting device A 425 starts its transmission. This can effectively create a second guard zone 437 around device B 430. A secondary device C 435 can detect the STR-CTS 440 from device B 430; as such, transmitting device C 435 can defer its own transmission for a pre-defined period of time. For example, secondary device C 435 can defer its own transmission for the time indicated in duration field of the STR-CTS (e.g., the duration field 315 of the STR-CTS 300 of FIG. 3). This can allow for a reduction in the number of collisions in the network.

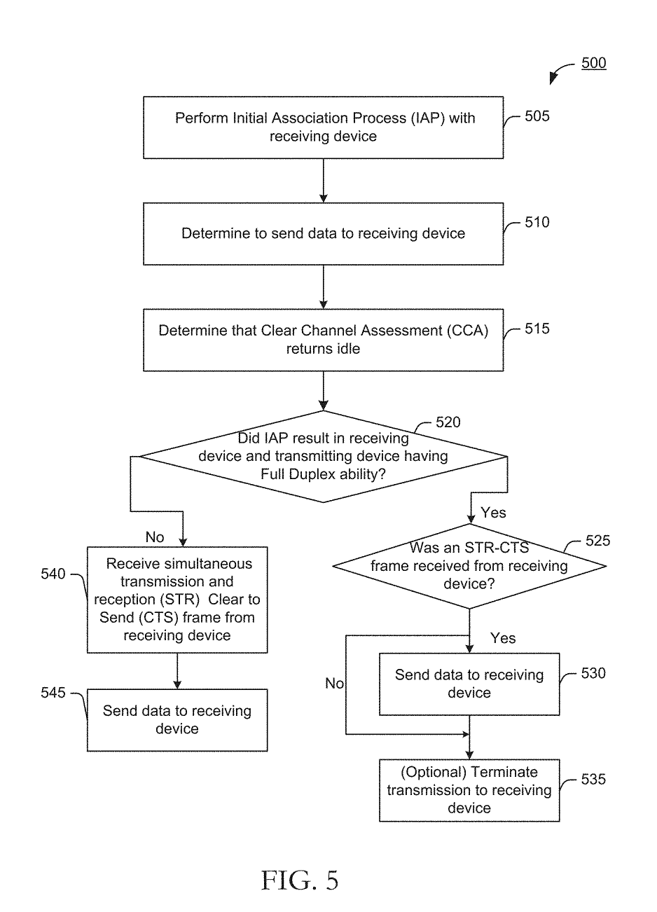

FIGS. 5-7 show exemplary flowcharts illustrating the operation of the devices (transmitting, receiving, and secondary devices) in accordance with the systems and methods disclosed herein.

FIG. 5 shows an exemplary flow diagram 500 in accordance with the disclosed systems and methods. In block 505, the transmitting device (e.g., the AP 102 of FIG. 1), can perform an Initial Association Process (IAP) with the receiving device (e.g., the receiving device(s) 124, 126, and 128 of FIG. 1). Next, in block 510, the transmitting device can determine to send data to the receiving device. In block 515, the transmitting device can determine that the CCA returned idle. This can serve as an indication that the receiving device is able to receive data communications from the transmitting device without a collision resulting from the receiving device having an ongoing information exchange. Next, in block 520, the transmitting device can determine whether or not the IAP resulted in the transmitting device and the receiving device having a full duplex (FB) ability. If the determination is that the receiving device or the transmitting device does not have the FD ability, the transmitting device can await the reception of an STR-CTS from the receiving device, as shown in block 540. Then in block 545, the transmitting device can send data to the receiving device. However, if at block 520, the determination is that the receiving device and the transmitting device do have the FD ability, then, at block 525, the transmitting device can await the reception of an STR-CTS from the receiving device within a pre-determined time. If the STR-CTS arrive within the pre-determined time, then the transmitting device sends data to the receiving device, as shown in block 530. However, if the STR-CTS does not arrive within the pre-determined time, then, at block 530, the transmitting device can optionally terminate the transmission to the receiving device. This can, for example, allow for the conservation of power in the transmitting device.

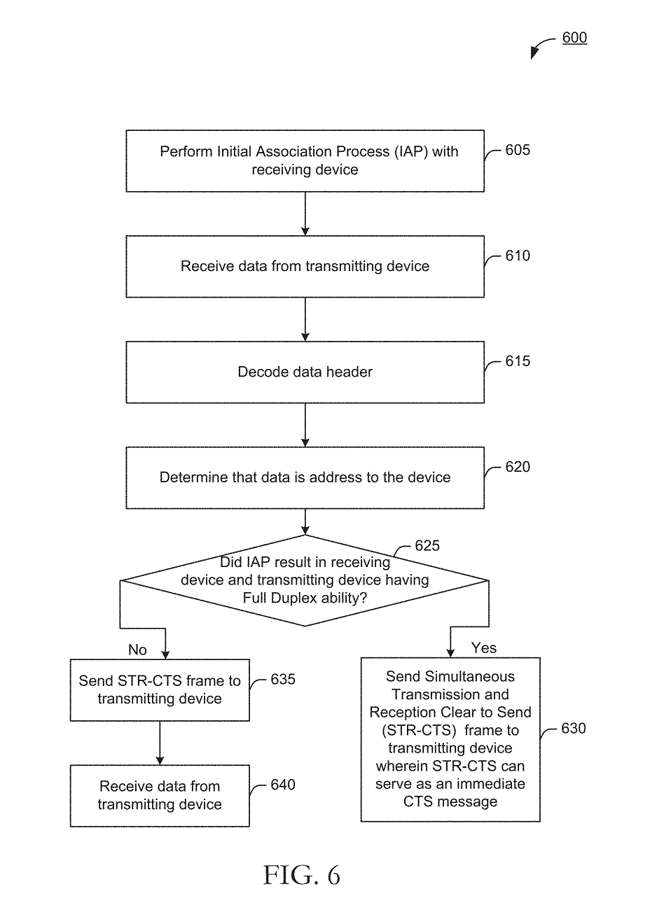

FIG. 6 shows an exemplary flow diagram 600 in accordance with the disclosed systems and methods. In block 605, the receiving device (e.g., the receiving device(s) 124, 126, And 128 of FIG. 1) can perform an IAP with the transmitting device (e.g., the AP 102 of FIG. 1). At block 610, the receiving device can receive data from the transmitting device. Next, at block 615, the receiving device can decode data from the header, e.g. the header of the data frame received from the transmitting device. In block 620, the receiving device can determine that the data is addressed to the receiving device, as opposed, for example, to other receiving devices. In block 625, the receiving device can determine whether the IAP resulted in the receiving device and the transmitting device having FD ability. If the result of the determination is that the receiving device and the transmitting device do have FD ability, then in block 630, the transmitting device can send an STR-CTS to the transmitting device wherein the STR-CTS can act as an immediate CTS message. This can allow for the transmitting device to terminate transmission earlier if no STR-CTS is detected within pre-determined time window. In some embodiments, if the receiving device has uplink data of its own, it can be sent in conjunction with the STR-CTS packet to use the available wireless resources more efficiently.

If, however, the result of the determination in block 625 is that the receiving device or the transmitting device does not have FD ability, then in block 635, the receiving device can send an STR-CTS frame to the transmitting device. The receiving device can then, in block 640, receive data from the transmitting device.

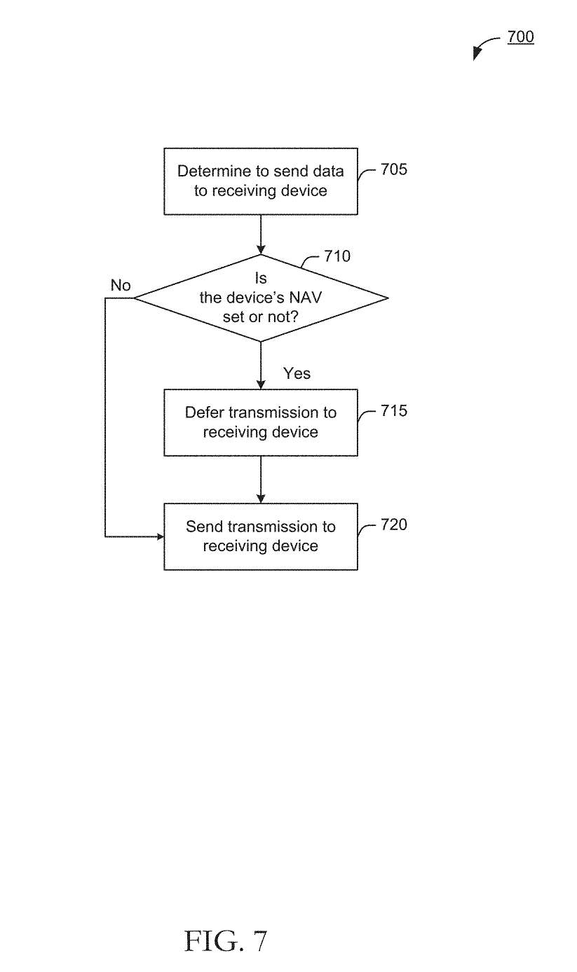

FIG. 7 shows an exemplary flow diagram 900 in accordance with the disclosed systems and methods. In block 705, a secondary receiving device (e.g., the receiving device(s) 124, 126, and 128 of FIG. 1), can determine to send data to the receiving device. If, in block 710, the secondary receiving device determines that the second device's network allocation vector (NAV) is not set, then at block 715, the second receiving device can defer data transmission to the receiving device. In some embodiments, the second devices NAV may be set for a number of different reasons relating to the dynamic network environment, for example, the detection of an STR-CTS by the secondary receiving device from the receiving device. If the STR-CTS is detected by the secondary receiving device, e.g., upon decoding a STR-CTS does not correspond to the secondary receiving device's address (e.g., the address provided in the RA field of detected STR-CTS), the secondary receiving device can defer its own transmissions. In some embodiments, the secondary receiving device can defer its own transmissions for a duration indicated in the duration field of detected STR-CTS If however, in block 710, the secondary receiving device does not detect a STR-CTS from the receiving device, then at block 720, the secondary receiving device can send data to the receiving device, or any devices in the general direction of the receiving device, for example, either in directional transmissions or in an omnidirectional transmission.

FIG. 8 shows a functional diagram of an exemplary communication station 1000 in accordance with some embodiments. In one embodiment, FIG. 8 illustrates a functional block diagram of a communication station that may be suitable for use as an AP 102 (FIG. 1) or communication station user device 120 (FIG. 1) in accordance with some embodiments. The communication station 1000 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in FIGS. 5-7.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device may, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device memory.

FIG. 9 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1004 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), a collision avoidance device 1119, a network interface device/transceiver 1120 coupled to antenna(s) 1130, and one or more sensors 1128, such as a global positioning system (GPS) sensor, compass, accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The collision avoidance device 1119 may be configured to perform a contention-based protocol (CBP) with a receiving device, receive a STR-CTS from the receiving device; and cause to send the data to the receiving device. Alternatively or additionally, the collision avoidance device 1119 can be configured to receive an initial portion of data from a transmitting device; decode a data header associated with the received initial portion of data; determine that the initial portion of data is addressed to the device; cause to send a STR-CTS to the transmitting device; and receive a remainder of the data from the transmitting device. In some aspects, the collision avoidance device 1119 can be configured to terminate the sending of the data to the receiving device if the receiving of the STR-CTS from the receiving device does not occur in a pre-determined time period.

It is understood that the above are only a subset of what the collision avoidance device 1119 may be configured to perform and that other functions included throughout this disclosure may also be performed by the collision avoidance device 1119.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

In an embodiment, a device, can include: at least one memory that stores computer-executable instructions; and at least one processor of the one or more processors configured to access the at least one memory, wherein the at least one processor of the one or more processors is configured to execute the computer-executable instructions to: determine to send data to a first device; perform a contention-based protocol (CBP) with the first device; identify a simultaneous transmission and reception clear to send (STR-CTS) frame received from the first device; determining to send the data to the first device based at least in part on the received STR-CTS frame; and cause to send the data to the first device. The at least one processor is configured to execute the computer-executable instruction to: determine that the STR-CTS was not received from the first device in a pre-determined time period; and terminate the sending of the data to the first device. The at least one processor is configured to execute the computer-executable instruction to: determine that the STR-CTS received from the first device is an immediate CTS frame. The device can include a transceiver configured to transmit and receive wireless signals. The device can include an antenna coupled to the transceiver.

In an embodiment, a device can include: at least one memory that stores computer-executable instructions; and at least one processor of the one or more processors configured to access the at least one memory, wherein the at least one processor of the one or more processors is configured to execute the computer-executable instructions to: identify an initial portion of data received from a first device; decode a data header associated with the received initial portion of data; determine that the initial portion of data is addressed to the device; cause to send a simultaneous transmission and reception clear to send (STR-CTS) frame to the first device; and identify a remainder of the data received from the first device. The at least one processor is configured to execute the computer-executable instruction to receive downlink License Assisted Access (LAA) transmissions. The at least one processor of the one or more processors is configured to execute the computer-executable instructions to cause to send a plurality of second STR-CTSs to the first device during the receiving of the remainder of the data from the first device. The at least one processor of the one or more processors is configured to execute the computer-executable instructions to cause to send a second data to the first device.

In an embodiment, a device can include: at least one memory that stores computer-executable instructions; and at least one processor of the one or more processors configured to access the at least one memory, wherein the at least one processor of the one or more processors is configured to execute the computer-executable instructions to: determine to send data to a first device; determine that a network allocation vector (NAV) associated with the device is set; and defer sending the data to the first device based at least in part on the NAV. The device does not have a simultaneous transmission and reception capability.

In an embodiment, a non-transitory computer-readable medium storing computer-executable instructions which, when executed by a processor, cause the processor to perform operations that can include: determining to send data to a first device; performing a contention-based protocol (CBP) with the first device; receiving a simultaneous transmission and reception clear to send (STR-CTS) frame from the first device; and causing to send the data to the first device. The computer-executable instructions cause the processor to further perform operations that can include: determining that the STR-CTS was not received from the first device in a pre-determined time period; and terminating the sending of the data to the first device. The computer-executable instructions cause the processor to further perform operations that can include: determining that the STR-CTS received from the first device is an immediate CTS frame.

In an embodiment, a non-transitory computer-readable medium storing computer-executable instructions which, when executed by a processor, cause the processor to perform operations that can include: identifying an initial portion of data received from a first device; decoding a data header associated with the received initial portion of data; determining that the initial portion of data is addressed to the device; causing to send a simultaneous transmission and reception clear to send (STR-CTS) frame to the first device; and identifying a remainder of the data received from the first device. The operations can include receiving downlink License Assisted Access (LAA) transmissions. The operations can include comprising causing to send a plurality of STR-CTSs to the first device during the receiving of the remainder of the data from the first device. The operations can include causing to send data to the first device.

In an embodiment, a method can include: determining to send data to a first device; performing a contention-based protocol (CBP) with the first device; receiving a simultaneous transmission and reception clear to send (STR-CTS) frame from the first device; and sending the data to the first device. The method can include: determining that the STR-CTS was not received from the first device in a pre-determined time period; and terminating the sending of the data to the first device. The method can include: determining that the STR-CTS received from the first device is an immediate CTS frame. An apparatus can include means for performing a method as described above. A system, which can include at least one memory device having programmed instruction that, in response to execution, cause at least one processor to perform the method described above. A machine readable medium including code, when executed, can cause a machine to perform the method described above.

In an embodiment, a method can include: identifying an initial portion of data received from a first device; decoding a data header associated with the received initial portion of data; determining that the initial portion of data is addressed to the device; causing to send a simultaneous transmission and reception clear to send (STR-CTS) frame to the first device; and identifying a remainder of the data received from the first device. The method further can include receiving downlink License Assisted Access (LAA) transmissions. The method can include sending a plurality of STR-CTSs to the first device during the receiving of the remainder of the data from the first device. The method can include causing to send data to the first device. An apparatus can include means for performing a method as described above. A system, which can include at least one memory device having programmed instruction that, in response to execution, cause at least one processor to perform the method described above. A machine readable medium including code, when executed, can cause a machine to perform the method described above.

In an embodiment, an apparatus can include: means for determining to send data to a first device; means for performing a contention-based protocol (CBP) with the first device; means for receiving a simultaneous transmission and reception clear to send (STR-CTS) frame from the first device; and means for sending the data to the first device. The apparatus can include: means for determining that the STR-CTS was not received from the first device in a pre-determined time period; and means for terminating the sending of the data to the first device. The apparatus can include: means for determining that the STR-CTS received from the first device is an immediate CTS frame.

In an embodiment, an apparatus can include: means for identifying an initial portion of data received from a first device; means for decoding a data header associated with the received initial portion of data; means for determining that the initial portion of data is addressed to the device; means for causing to send a simultaneous transmission and reception clear to send (STR-CTS) frame to the first device; and means for identifying a remainder of the data received from the first device. The apparatus can include means for receiving downlink License Assisted Access (LAA) transmissions. The apparatus can include means for sending a plurality of STR-CTSs to the first device during the receiving of the remainder of the data from the first device. The apparatus can include means for causing to send data to the first device.

In an embodiment, a non-transitory computer-readable medium storing computer-executable instructions which, when executed by a processor, cause the processor to perform operations that can include: determining to send data to a first device; determining that a network allocation vector (NAV) associated with the device is set; and deferring sending the data to the first device based at least in part on the NAV. The device does not have a simultaneous transmission and reception capability.

In an embodiment, a method can include: determining to send data to a first device; determining that a network allocation vector (NAV) associated with the device is set; and deferring sending the data to the first device based at least in part on the NAV. The device does not have a simultaneous transmission and reception capability. An apparatus can include means for performing a method as described above. A system, which can include at least one memory device having programmed instruction that, in response to execution, cause at least one processor to perform the method described above. A machine readable medium including code, when executed, can cause a machine to perform the method described above.

In an embodiment, a method can include: determining to send data to a first device; determining that a network allocation vector (NAV) associated with the device is set; and deferring sending the data to the first device based at least in part on the NAV. The device does not have a simultaneous transmission and reception capability.

In an embodiment, an apparatus can include: means for determining to send data to a first device; means for determining that a network allocation vector (NAV) associated with the device is set; and means for deferring sending the data to the first device based at least in part on the NAV. The device does not have a simultaneous transmission and reception capability. An apparatus can include means for performing a method as described above. Machine-readable storage including machine-readable instructions, when executed, can implement a method as described above. Machine-readable storage including machine-readable instructions, when executed, can implement a method or realize an apparatus as claimed in any preceding claim.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and at least one processor of the one or more processors configured to access the at least one memory, wherein the at least one processor of the one or more processors is configured to execute the computer-executable instructions to:
determine to send data to a first device;
perform a contention-based protocol (CBP) with the first device;
identify a simultaneous transmission and reception clear to send (STR-CTS) frame received from the first device;
determining to send the data to the first device based at least in part on the received STR-CTS frame; and
cause to send the data to the first device.

2. The device of claim 1, wherein the at least one processor is configured to execute the computer-executable instruction to:
determine that the STR-CTS was not received from the first device in a pre-determined time period; and
terminate the sending of the data to the first device.

3. The device of claim 1, wherein the at least one processor is configured to execute the computer-executable instruction to:
determine that the STR-CTS received from the first device is an immediate CTS frame.

4. The device of claim 1, further comprising a transceiver configured to transmit and receive wireless signals and an antenna coupled to the transceiver.

5. The device of claim 4, further comprising a communication circuitry that determines the data to be sent by the transceiver and the antenna.

6. A device, comprising:
at least one memory that stores computer-executable instructions; and
at least one processor of the one or more processors configured to access the at least one memory, wherein the at least one processor of the one or more processors is configured to execute the computer-executable instructions to:
identify an initial portion of data received from a first device;
decode a data header associated with the received initial portion of data;
determine that the initial portion of data is addressed to the device;
cause to send a simultaneous transmission and reception clear to send (STR-CTS) frame to the first device; and
identify a remainder of the data received from the first device.

7. The device of claim 6, wherein the at least one processor is configured to execute the computer-executable instruction to receive downlink License Assisted Access (LAA) transmissions.

8. The device of claim 6, wherein the at least one processor of the one or more processors is configured to execute the computer-executable instructions to cause to send a plurality of second STR-CTSs to the first device during the receiving of the remainder of the data from the first device.

9. The device of claim 6, wherein the at least one processor of the one or more processors is configured to execute the computer-executable instructions to cause to send a second data to the first device.

10. A device, comprising:
at least one memory that stores computer-executable instructions; and
at least one processor of the one or more processors configured to access the at least one memory, wherein the at least one processor of the one or more processors is configured to execute the computer-executable instructions to:
determine to send data to a first device;
determine that a network allocation vector (NAV) associated with the device is set; and
defer sending the data to the first device based at least in part on the NAV.

11. The device of claim 10, wherein the device does not have an simultaneous transmission and reception capability.

12. A non-transitory computer-readable medium storing computer-executable instructions which, when executed by a processor, cause the processor to perform operations comprising:
determining to send data to a first device;
performing a contention-based protocol (CBP) with the first device;
receiving a simultaneous transmission and reception clear to send (STR-CTS) frame from the first device; and
causing to send the data to the first device.

13. The non-transitory computer-readable medium of claim 12, further comprising the processor being configured to execute the computer-executable instructions to:
determine that the STR-CTS was not received from the first device in a pre-determined time period; and
terminate the sending of the data to the first device.

14. A non-transitory computer-readable medium storing computer-executable instructions which, when executed by a processor, cause the processor to perform operations comprising:
identifying an initial portion of data received from a first device;
decoding a data header associated with the received initial portion of data;
determining that the initial portion of data is addressed to the device;
causing to send a simultaneous transmission and reception clear to send (STR-CTS) frame to the first device; and
identifying a remainder of the data received from the first device.

15. The non-transitory computer-readable medium of claim 16, wherein the processor is further configured to perform operations comprising causing to send a plurality of STR-CTSs to the first device during the receiving of the remainder of the data from the first device.

16. The non-transitory computer-readable medium of claim 15, wherein the processor is further configured to perform operations comprising causing to send data to the first device.

17. A method comprising:
determining to send data to a first device;
performing a contention-based protocol (CBP) with the first device;
receiving a simultaneous transmission and reception clear to send (STR-CTS) frame from the first device; and
sending the data to the first device.

18. The method of claim 17, the method further comprising determining that the STR-CTS was not received from the first device in a pre-determined time period; and
terminating the sending of the data to the first device.

19. A method comprising:
identifying an initial portion of data received from a first device;
decoding a data header associated with the received initial portion of data;
determining that the initial portion of data is addressed to the device;
causing to send a simultaneous transmission and reception clear to send (STR-CTS) frame to the first device; and
identifying a remainder of the data received from the first device.

20. The method of claim 19, wherein the method further comprises sending a plurality of STR-CTSs to the first device during the receiving of the remainder of the data from the first device.
